(19) United States
(12) Patent Application Publication
(10) Pub. No.: US 2026/0207430 A1
(43) Pub. Date: Jul. 23, 2026

(54) Multi-part closure device for active substance containers

(71) Applicant: Presspart GmbH & Co. KG, Marsberg (DE)

(72) Inventors: Fredrik Andersson, Nidau (CH); Christoph Schulte, Marsberg (DE); Juanjo Forcadell, L'Arboc del Penedes, Tarragona (ES)

(21) Appl. No.: 19/138,337

(22) PCT Filed: Jul. 17, 2023
(86) PCT No.: PCT/EP2023/069782

§ 371 Date: Jun. 12, 2025

(30) Foreign Application Priority Data
Dec. 19, 2022 (EP) 22214678.9

(51) Int. Cl. A61J 1/14

(52) U.S. Cl. CPC A61J 1/1425

(57) ABSTRACT

The invention relates to a multi-part closure device (2) for coupling to a medical active substance container (1) with a suitable collar (101), wherein the multi-part closure device (2) comprises a sealing plug (20), a plug securing device (21) and preferably a protective cover (22). The sealing plug (20) can be secured to the active substance container (1) by means of the plug securing device (21), sealing an opening in a bottle neck (10) of the active substance container (1) and allowing airtight removal of liquid active substance. The plug securing device (21) comprises a securing cage (210) with a centric ring (2101), a central opening and a side wall (2102), which has a plurality of undercut webs (2103) formed along the side wall (2102), which are adapted to engage on the collar (101) of the bottle neck (10), wherein the undercut webs (2103) are bent in a tilted manner in the direction of a longitudinal axis (L) of the plug securing device (21). The plug securing device (21) furthermore has an outer cage shell (211), which surrounds the securing cage (210) in a radially outwardly offset manner and has a central opening (2111); wherein the cage shell (211) is made of metal or plastic and/or wherein the cage shell (211) is connected to the securing cage (210) by material closure, in particular by gluing or welding, by form closure or by force closure.

### TECHNICAL FIELD

The present invention relates to a multi-part closure device for coupling to a medical active substance container with a suitable collar, wherein the multi-part closure device comprises a sealing plug, a plug securing device and preferably a protective cover, wherein the sealing plug is adapted to be secured to the active substance container by means of the plug securing device, thereby sealing an opening in a bottle neck and permitting airtight removal of liquid active substance. Furthermore, the present invention relates to a medical active substance container with a multi-part closure device and the use of a multi-part closure device.

### STATE OF THE ART

The aseptic storage and transportation of medical devices and medical active substances in medical active substance containers is of great importance in many areas of medicine. Of particular interest here are medical active substance containers in the form of medical injection vials, also referred-to simply as “vials”, whereby liquid medical active substances are removed from such medical active substance containers with the aid of draw-up and/or application needles. Vaccine containers, vaccine vials or vaccine ampoules are a specific example of the medical active substance containers or vials in question.

Wherever vaccines are administered in liquid form, care must be taken to ensure that the vaccines or vaccine concentrates are not contaminated during storage or that vaccines are taken from medical vaccine containers that have already been unknowingly opened. In addition to aseptic storage, a guaranteed seal must also be recognizable until first use so that contamination of the contents can be ruled out with certainty. Accordingly, the medical vaccine containers are provided with a disposable closure device, as it is not intended to make the medical active substance containers resealable for prolonged use. The medical specialties of interest here, in which active substances are administered in such medical active substance containers, are in particular immunology, virology and oncology, but this is not to be understood as an exhaustive list.

A multi-part closure device for a medical active substance container is known from EP2948122. The medical active substance container has a bottle neck with a collar, whereby a rubber plug is partially inserted into the bottle neck and is fixed there non-detachably by means of a retaining ring. The rubber plug has a sealing lip, which is operatively connected to the inner surface of the bottle neck in a sealing manner. The retaining ring surrounds an edge of the rubber plug and a collar end bead and is formed from a metal sheet. By pressing the retaining ring onto the neck of the bottle and bending the edge of the retaining ring on the bottle side, the rubber plug cannot become detached from the medical active substance container and vaccines can be stored aseptically. Additional means are provided to form a plug securing device, which additionally enclose the rubber plug and the retaining ring, and a movable lid is attached. When the lid is opened and the area at the level of the center of the rubber plug is exposed, vaccine can be removed from the interior of the medical active substance container by piercing a draw-up and/or inoculation syringe or a draw-up and/or application needle through the thinner center of the rubber plug. In EP2948122, complex additional means are provided which go far beyond the simple securing of the rubber plug with a sheet metal ring. This design is technically complex and not suitable for mass production.

In addition to the complexity of manufacturing the multi-part closure device from EP2948122 and the larger number of different components, filling and closing the active substance containers also appears to be complex and not possible with simple filling systems.

### SUMMARY OF THE INVENTION

The present invention has the object of creating a multi-part closure device for a medical active substance container which achieves a secure closure with improved tightness, comprises as few components as possible, has an increased securing effect with low weight and nevertheless enables simplified attachment to the bottle neck opening of the medical active substance container, so that the multi-part closure devices can also be easily applied on site during the filling process.

The object underlying the invention is achieved by a multi-part closure device with the features of claim 1. Advantageous embodiments of the present invention are listed in the subclaims.

Preferably, the multi-part closure device also has a protective cover which additionally protects the puncture area, can be easily removed before use and further optionally has windows through which the integrity of the closure device can be checked.

All variations of feature combinations or minor adaptations of the invention can be found in the detailed description, are illustrated in the figures and have been included in the dependent patent claims.

### BRIEF DESCRIPTION OF THE DRAWINGS

The object of the invention is described in detail below in context with reference to the attached drawings. Necessary features, details and advantages of the invention result from this following description, whereby a preferred embodiment of the invention and some additional features or optional features are listed in detail.

Further features, details and advantages of the invention are shown in the following description of preferred embodiments of the invention and in the drawings. It shows:

FIG. 1 an exploded view of a bottle neck of a medical active substance container and a matching multi-part closure device with protective cover;

FIG. 2 a sectional view of a multi-part closure device with protective cover, placed on a bottle neck of a medical active substance container;

FIG. 3 a partial sectional view of a multi-part closure device with sealing plug, securing cage, outer cage shell and protective cover;

FIG. 4 a perspective view from below of a multi-part closure device with protective cover without medical active substance container;

FIG. 5 a perspective view of a sealing plug alone;

FIG. 6a a perspective view of the securing cage in the deployable state;

FIG. 6b sectional view of the securing cage from FIG. 6a in combination with a sealing plug;

FIG. 7a a perspective view of an alternative securing cage in the deployable state, FIG. 7b sectional view of the securing cage from FIG. 7a in combination with a sealing plug;

FIG. 8 a perspective view of a further alternative securing cage in the deployable state;

FIG. 9a shows a perspective view of the medical active substance container with the plug securing device with protective cover, with recesses and plastic windows in the protective cover;

FIG. 9b an exploded view of recesses corresponding to a protective cover and a window layer as produced on a corresponding plastic injection molding machine; and

FIG. 10 a sectional view of a transport container in which prefabricated storage pallets with several unfilled medical active substance containers and several non-attached multi-part closure devices are stored.

### DETAILED DESCRIPTION OF THE INVENTION

The present invention is explained by way of example with reference to the attached figures, which, however, are not intended to limit the scope of protection of the invention.

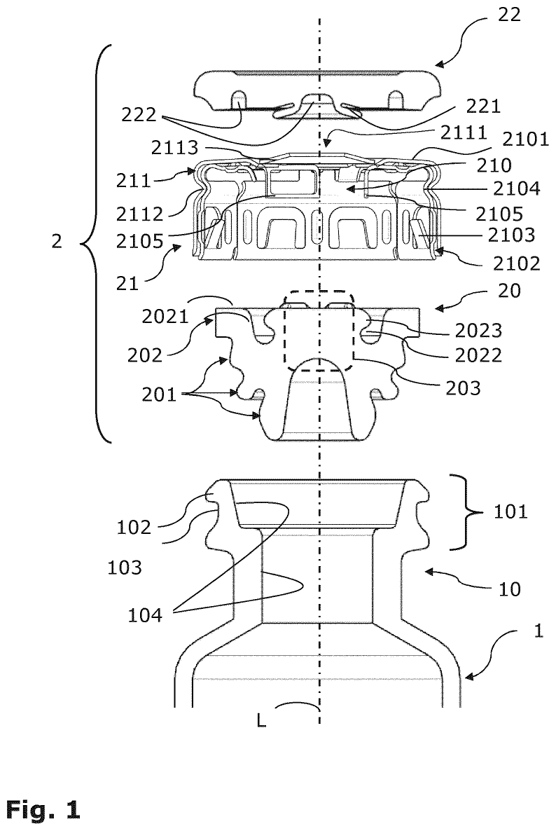

FIG. 1 shows an embodiment of the invention in the form of a medical active substance container 1 with a multi-part compact closure device 2. Such medical active substance containers 1 can also be referred to as vaccine vials, vaccine ampoules, vaccine vials, multi-dose containers, medical vials for aseptic storage and removal of liquid vaccines and vaccine concentrates as a medical active substance. These medical active substance containers 1 are preferably made of glass or plastic and are commercially available in standardized sizes. After filling the medical active substance container 1, the multi-part closure device 2 is placed on a bottle neck 10 of the medical active substance container 1. The multi-part closure device 2 is to be stored on the bottle neck 10 in a non-detachable and non-removable manner so that no contents can escape from the medical active substance container 1. The contents are not shown here. Contamination of the interior of the medical active substance container 1 during transportation and storage must be avoided. After opening or the first use of the contents of the medical active substance container 1, there are often only a few hours before the contents for example a vaccine-become unusable.

According to one aspect of the invention, a multi-part closure device 2 according to the invention comprises at least one sealing plug 20 and a multi-part plug securing device 21, with which the sealing plug 20 can be fastened to a collar 101 of the bottle neck 10. Due to the configuration of the plug securing device 21 presented here, the multi-part closure device 2 can be pressed onto the collar 101 in the direction of a longitudinal axis L of the medical active substance container 1 and means of the plug securing device 21 engage with the collar 101.

The closure device 2 is not intended for multiple use, i.e. the opening and closing of the closure device 2, but remains immobile after attachment to the collar 101 sealing the interior of the medical active substance container 1.

A protective cover 22 is intended as an optional part of the multi-part closure device 2, which provides additional mechanical protection.

In FIG. 1, the individual components are shown not yet assembled and are presented individually from bottom to top.

The bottle neck 10 of the medical active substance container 1 has a collar 101 which has a collar end bead 102, an outer collar surface 103 and an inner contact surface 104. The multi-part closure device 2 according to the invention is plugged together with the collar end bead 102, wherein a part of the closure device 2 engages behind the collar end bead 102 so that the closure device 2 cannot slip relative to the collar 101 in the assembled state. The sealing plug 20 is preferably made of an elastomer, in particular of rubber or of a thermoplastic elastomer (TPE), and is tapered overall from the top, i.e. from the side facing away from the medical active substance container 1, towards the bottom, i.e. is essentially conical in shape.

The sealing plug 20 has a profiled shape and at least one sealing lip 201 and one edge 202 are arranged on the outer circumferential side surface of the sealing plug 20. In this way, the sealing plug 20 can be pressed onto the bottle neck 10 in the longitudinal direction L and arranged and fastened so that it partially protrudes into it. In order to increase the tightness, three sealing lips 201 along the outer side surface of the sealing plug 20, which in the assembled state come to lie along the inner contact surface 104 of the bottle neck 10, have proven to be effective. The edge 202 projects radially beyond the tapered part of the sealing plug 20 and remains outside the bottle neck 10 in the assembled state.

The tapered part of the sealing plug 20 is recessed into the bottle neck 10 during assembly, with the edge 202 of the sealing plug 20 remaining outside the collar 101 and the bottle neck 10. A cage support surface 2021 and a circumferential cage edge recess 2022, in the form of an annular groove, are arranged along the circumferential edge 202. Preferably, the cage edge recess 2022 has a circumferential bead 2023, which is formed by an undercut in a lower section of the cage edge recess 2022 on a radially inner surface of the cage edge recess 2022.

A central tapered plug 203 is provided in the sealing plug 20, also indicated by a dashed line in FIG. 1, so that easy access to the interior of the medical active substance container 1 is achieved during subsequent removal of the contents of the medical active substance container 1. This tapered plug 203 makes it easier to push a drawing-up and/or application needle through.

In addition to the sealing plug 20, which is optimized compared to the prior art, the multi-part closure device 2 has a plug securing device 21 consisting of two parts, a securing cage 210 and an outer cage shell 211.

The securing cage 210, which in the assembled state is on the inside, closer to the longitudinal axis L, is preferably formed from a one-piece continuous sheet metal stamped part which comprises a centric ring 2101 and a circumferential side wall 2102 with several undercut webs 2103. The centric ring 2101 leaves a central opening in the securing cage 210 open so that the drawing-up and/or application needle can be pushed through. The size of the central opening is preferably as large as the diameter of the plug taper 203 in the sealing plug 20 or even larger.

The undercut webs 2103 are arranged in the side wall 2102 in such a way that they have an inclination towards the longitudinal axis L and can thus be brought into engagement below the collar end bead 102 on the collar 101 in the assembled state. In the view according to FIG. 1, an inclination from bottom to top in the direction of the longitudinal axis L is clearly recognizable. Due to the inclination of the undercut webs 2103 or tilting in the direction of the longitudinal axis L, engagement of the undercut webs 2103 behind the collar end bead 102 or the undercut below the collar end bead 102 is possible. The securing cage 210 and the sealing plug 20 are efficiently secured and fixed to the medical active substance container 1 in the axial direction or in the direction of the longitudinal axis L by this mechanism.

A cage edge bead 2104 is arranged at least partially circumferentially in the side wall 2102. Here, the cage edge bead 2104 is arranged at a height such that, in the assembled state of the multi-part closure device 2, it is positioned between the edge 202 of the sealing plug 20 and the collar end bead 102 outside the collar 101.

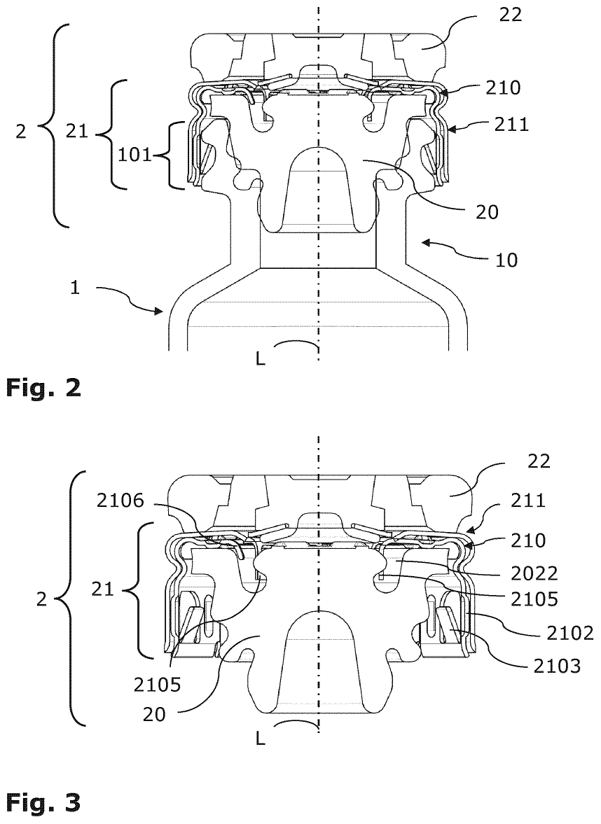

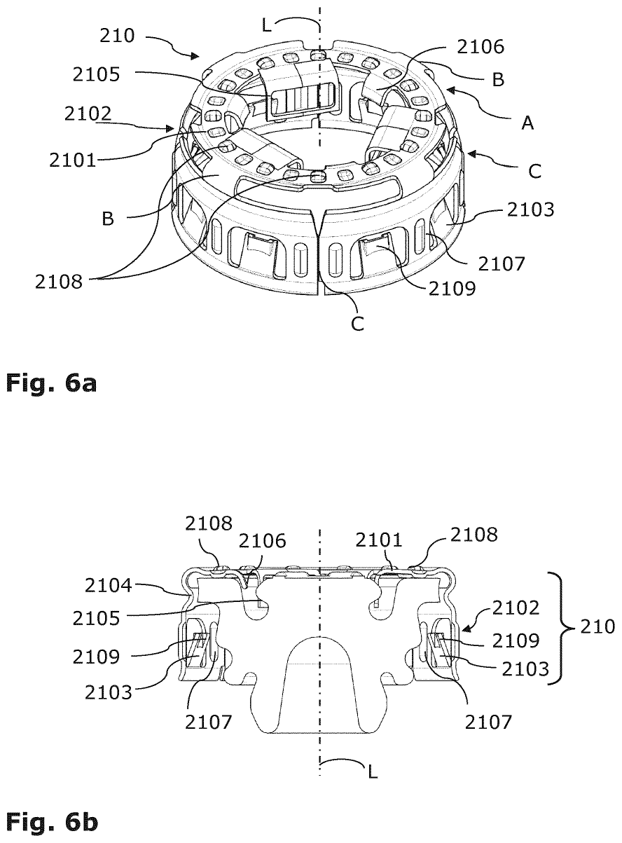

Also optionally, a plug engagement edge 2105 is bent over at the end of the centric ring 2101. Here, a shape is achieved by folding the sheet metal of the securing cage 210 so that, in the assembled state, the plug engagement edge 2105 can engage in the cage recess 2022 of the sealing plug 20, whereby the securing cage 210 is fixed to the sealing plug 20, while the centric ring 2101 rests directly on the cage support surface 2021, which can be seen in FIG. 2. Preferably, the stopper engagement edge 2105 has a plurality of frame shapes arranged in the direction of rotation, which are bent by 90°, i.e. running parallel to the longitudinal axis L, so that in the assembled state the frame shapes partially embrace the undercut of the cage recess 2022 in order to center the sealing stopper 20 relative to the securing cage 210 and thus also to the bottle neck 10. This stopper engagement edge 2105 with several frame shapes arranged in the direction of rotation is shown even more clearly in FIG. 6a. According to a further embodiment of the invention, the securing cage 210 is alternatively or additionally secured to the sealing plug 20 by firmly connecting the sealing plug 20 to the securing cage 210, for example by adhesive bonding, welding or by means of a form closure, such as a snap fit.

An outer cage shell 211 is mounted over the securing cage 210 as part of the plug securing device 21. This cage shell 211 is also preferably made of a metal sheet, although a correspondingly shaped plastic cover would also be possible. The cage shell 211 runs essentially parallel to the securing cage 210 and rests against it. The cage shell 211 is designed as an open sleeve with a central opening 2111 and an at least partially circumferential cage shell bead 2112. Once plugged together in the direction of the longitudinal axis L, the cage shell 211 can no longer be easily removed from the securing cage 210. When plugged together in this way, the plug securing device 21 can be pressed over the sealing plug 20 and the collar 101. According to a further embodiment of the invention, the plug securing device 21 is first placed over the sealing plug 20 and connected thereto, wherein the assembly comprising the securing cage 210, cage shell 211, protective cover 22 and sealing plug 20 is then placed as a unit over the collar 101 in order to secure the plug securing device 21 to the medical active substance container 1. The cage shell 211 completely envelops the securing cage 210, while only the centric surfaces at the top and bottom of the securing cage 210 and the cage shell 211 remain accessible in the assembled state and a drawing-up and/or application needle can be pushed through the centric opening 2111 and the centric ring 2101 with the centric opening.

The combination of securing cage 210 and cage shell 211 enables a firmly acting closure device. The securing cage 210 and cage shell 211 can be designed in such a way that the cage shell 211 tightly encloses the securing cage 210. This is particularly advantageous if both elements are made of metal, e.g. stamped sheet metal parts. The dimensions of the closure device are then similar or even essentially correspond to the dimensions, in particular in width and height, of regular crimp-closures, such as crimped vials. In this way, the closure device is also suitable for use in conjunction with standardized transfer systems, such as draw-up or injection syringes, transfer devices, such as transfer needles, or syringe adapters. According to a further embodiment of the invention, the cage shell 211 is connected to the securing cage 210 by means of a material closure, in particular by gluing or welding. Mechanical forming, such as crimp connections, can thus be dispensed with. It is of course also possible to connect the cage shell 211 to the securing cage 210 by form closure or by force closure.

Additional means are provided for detachably fastening the additional protective cover 22 directly to the outer cage shell 211 or to the securing cage 210. These additional means are arranged either directly on the securing cage 210 or, as shown in the embodiment here, directly on the outer cage shell 211. The additional means shown here is a cover engagement 2113 formed on the edge of the central opening 2111 as part of the outer cage shell 211. The cover engagement 2113 is inclined towards the longitudinal axis L, namely upwards, in the direction of the protective cover 22.

The protective cover 22 is preferably designed as a plastic component, is generally rotationally symmetrical and has a concentric area with an engagement edge 221. The engagement edge 221 runs around an area of the inner surface of the cover, the surface which faces the outer cage shell 211. When the protective cover 22 is mounted on the outer cage shell 211, the cover engagement 2113 engages in the engagement edge 221, whereby the protective cover 22 is held releasably on the outer cage shell 211 and forms part of the multi-part closure device 2. The protective cover 22 can be shaped as a profile and have a central taper 222 or optional recesses 222, which lead to increased stability or are selected to save material.

The protective cover 22 is optional and not absolutely necessary. However, in order to be better protected against external influences, the protective cover 22 should be detachably connected to the outer cage shell 211 or the securing cage 210 of the plug securing device 21, so that the protective cover 22 can be removed from the plug securing device 21 before use.

FIG. 2 shows the assembled state of the multi-part closure device 2 according to the invention as shown in FIG. 1. The arrow on the longitudinal axis L also indicates the direction in which the closure device 2 is pushed together or pressed onto the bottle neck 10. Once assembled, undercut webs 2103 in the side wall 2102 engage behind the collar end bead 102 at several points concentrically around the collar 101 and the position of the sealing plug 20 on the inner contact surface 104 is secured, while the at least one sealing lip 201 closes in a sealing manner. The side wall 2102 of the securing cage 210 and the outer cage shell 211 rest against the outer collar surface 103. Even when pulled in the direction of the longitudinal axis L, away from the medical active substance container 1, the securing cage 210 and thus the sealing plug 20 remain motionless. Due to the bending or pretensioning of the undercut webs 2103 in the side wall 2102, the pretensioning would be even greater at higher tensile forces, so that a high resistance to tensile forces is achieved. The effect of the plug securing device 21 is maximum, with low material consumption and low weight of the entire plug securing device 21.

FIG. 3 shows the assembled state of the multi-part closure device 2 according to the invention as shown in FIG. 1 without the medical active substance container 1, but with sealing stopper 20, plug securing device 21 and protective cover 22. The plug securing device 21 is composed of the securing cage 210 and the outer cage shell 211, which radially surrounds the securing cage 210. On the sealing plug 20, the cage edge recess 2022 is recessed radially towards the longitudinal axis L of the sealing plug 20, so that the cage edge recess 2022 has a circumferential bead which is formed by an undercut in a lower section of the cage edge recess 2022 on a radially inner surface of the cage edge recess 2022. An annular tab 2106 and a plug engaging edge 2105 engage in this cage edge recess 2022, which has a plurality of frame shapes arranged in the direction of rotation, which are bent through 90°, i.e. running parallel to the longitudinal axis L, so that in the assembled state the frame shapes partially embrace the undercut of the cage edge recess 2022. Undercut webs 2103 are shown in the side wall 2102 of the securing cage 210, which engage behind the collar end bead of the medical active substance container (not shown).

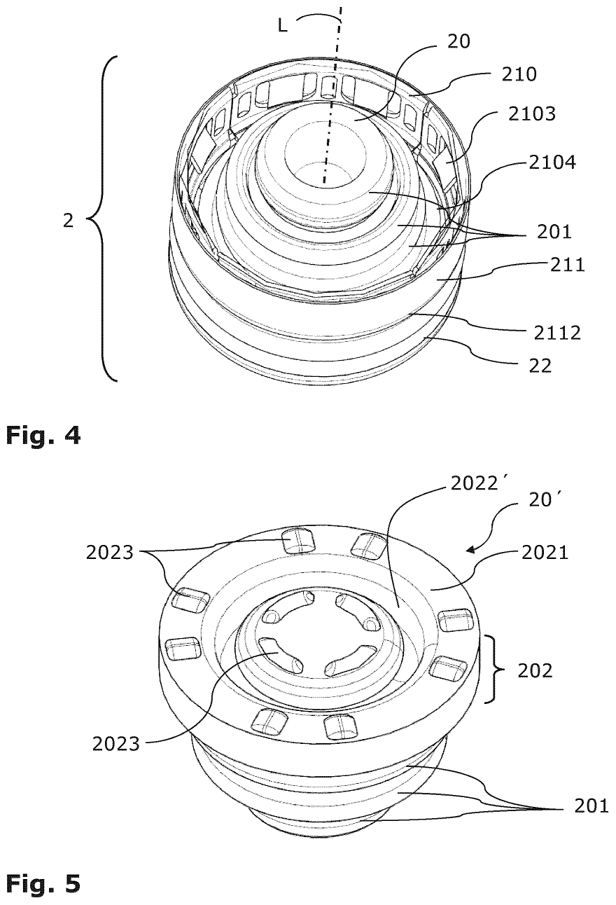

In the bottle-side view according to FIG. 4 looking from below at the multi-part closure device 2 shown in FIGS. 1, 2 and 3 with protective cap 22 and sealing plug 20 pointing out of the paper plane along the longitudinal axis L, some preferred features are clearly recognizable. The sealing lips 201, which project radially outwards from the sealing plug 20. Preferably, three stepped sealing lips are arranged at different heights parallel to the longitudinal axis L. The circular circumferential cage edge bead 2104 in the securing cage 210 and the parallel cage shell bead 2112 in the outer cage shell 211 are also preferred features.

A preferred embodiment of the sealing plug is shown in FIG. 5. On the sealing plug 20′—as before—the cage edge recess 2022′ is recessed radially oriented towards the longitudinal axis L of the sealing plug 20′, so that the cage edge recess 2022′has a circumferential bead, which is formed by an undercut in a lower section of the cage edge recess 2022′ on a radially inner surface of the cage edge recess 2022′. An annular tab and a plug engagement edge of the securing cage 210 (not shown) engage in this cage edge recess 2022′.

In order to optimize the sealing plug 20′, several plug beads 2023 are arranged along the outer surface, here four along the surface in the center of the sealing plug 20′ and here a total of eight along the outer outer ring surface of the edge 202 of the sealing plug 20′. These plug beads 2023 ensure that the securing cage 210 is spaced apart from the surface of the sealing plug 20′.

FIG. 6a shows a securing cage 210 according to FIGS. 1 to 3 without additional components of the locking device. This has several, preferably three, ring tabs 2106 and several, preferably three, plug engagement edges 2105. The ring tabs 2101 are designed to engage on the radially outer sides of the cage recess of the sealing plug (not shown) and the plug engagement edge 2105 of the plug engagement edge 2105 has several frame shapes arranged in the direction of rotation, which are bent through 90°, so that in the assembled state the frame shapes partially embrace the undercut of the cage recess 2022.

Optional means are provided to increase the stability of the securing cage 210, which is of lightweight construction. For example, the undercut webs 2103 in the side wall 2102 are provided with additional web reinforcements 2109. These are in the form of thickenings at the end of the undercut webs 2103. The side wall 2102 itself is reinforced by side wall reinforcements 2107 in the form of beading or embossing. Here, the beads of the side wall reinforcements 2107 run parallel to the longitudinal axis L along the side wall 2102 in the various edge segments A. The side wall reinforcements 2107 also serve to form a defined distance from the cage shell (not shown).

Beads running radially to the longitudinal axis L can also be embossed along the shortened centric ring 2101 of the securing cage 210, which are designated and marked as ring reinforcement 2108. Like the side wall reinforcements 2107, the bead or ring reinforcement 2108 also serves to create a defined distance from the cage shell (not shown).

In order to obtain a securing cage 210 that is as stable as possible, that can be easily connected to the outer cage shell 211 and that can be easily attached to a bottle neck 10 when placed around the sealing plug 20, the securing cage 210 is preferably manufactured in a segmented form. This design is special and independent of the optimizations of the sealing plug shape. The one-piece securing cage 210 is manufactured from a metal profile in lightweight construction, whereby the metal profile is punched out, provided with beads and bent accordingly.

The additional optional reinforcements of the securing cage 210 according to FIG. 6a are again clearly shown in FIG. 6b, whereby the outer cage shell 211 has been omitted. The operative connection between the securing cage 210 and the collar with inner collar taper on the bottle neck of the medical active substance container (not shown) is permanent after pressing on the multi-part closure device 2 in the direction of the longitudinal axis L.

According to FIG. 6a, the Centric Ring 2101 Holds Several Edge Segments a together via several hinges B. Four edge segments A are selected here, each of which is non-detachably connected to one another via a hinge B, as a band between the centric ring 2101 and edge segment A. Two undercut webs 2103 are formed or recessed in each of the edge segments A, which form parts of the side wall 2102. Facing the centric ring 2101, a part of the cage edge bead 2104 extends in each edge segment A (shown in FIG. 6b).

In order to bring the securing cage 210 into the assembled state, the edge segments A are bent through approximately 90° to the longitudinal axis L in such a way that they form a side wall 2102 that is closed around the centric ring 2101, as shown in FIG. 6 a. The ends of the edge segments A, i.e. the connection points C, are shaped to match each other in the direction of rotation and can interlock. This forms a circumferentially stable side wall 2102. Optionally, the edge segments A can also be welded together at their ends, the connection points C, which can be carried out automatically by laser welding or spot welding, for example. Other joining methods are also possible. In the assembled state as shown in FIG. 6a, the securing cage 210 can function as part of the plug securing device 21 in an operatively connected manner with the outer cage shell 211, as shown in FIGS. 2 and 3.

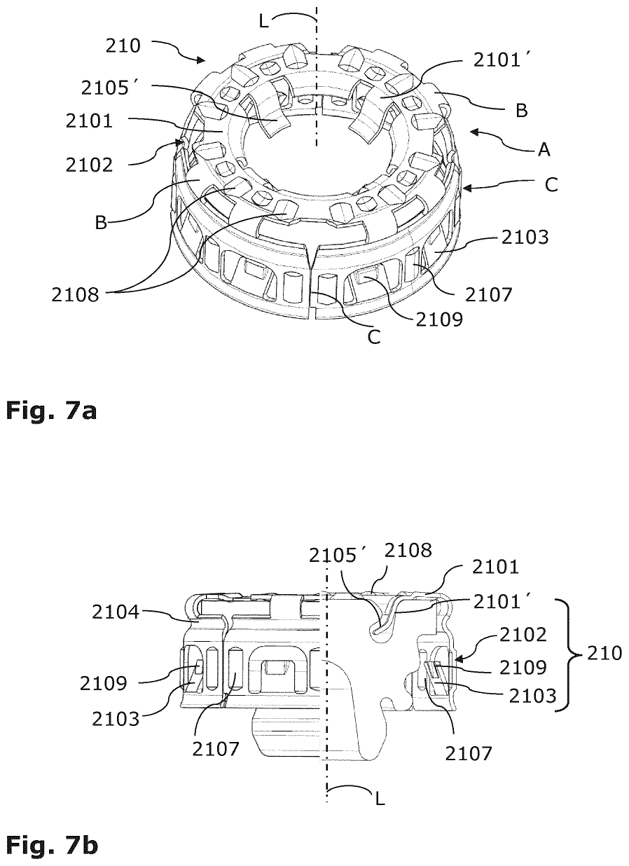

FIG. 7a shows an alternative securing cage 210 to that shown in FIG. 6a, which has several ring lugs 2101′, each with a plug-engaging edge 2105′. Four such ring tabs 2101′ are shown here as an example, the plug engagement edge 2105 of which can engage in cage recesses 2022, 2022′ on the sealing plug 20. Optional means are also provided to increase the stability of the securing cage 210, which is of lightweight construction. For example, the undercut webs 2103 in the side wall 2102 are provided with additional web reinforcements 2109. These are in the form of thickenings at the end of the undercut webs 2103. The side wall 2102 itself is reinforced by side wall reinforcements 2107 in the form of beading or embossing. Here, the beads of the side wall reinforcements 2107 run parallel to the longitudinal axis L along the side wall 2102 in the various edge segments A. The side wall reinforcements 2107 also serve to form a defined distance from the cage shell (not shown), i.e. the securing cage 210 and the cage shell 211 are kept at a distance from one another, at least in some areas. This means that several air gaps are formed between the securing cage 210 and the cage shell 211. As a result, improved sterilization, e.g. by ethylene oxide (EtO) sterilization processes, is achieved in the assembled state.

Beads running radially to the longitudinal axis L can also be embossed along the shortened centric ring 2101 of the securing cage 210, which are designated and marked as ring reinforcement 2108. Like the side wall reinforcements 2017, the bead or ring reinforcement 2108 also serves to create a defined spacing.

The additional optional reinforcements of the securing cage 210 are again clearly shown in FIG. 7b, whereby the outer cage shell 211 has been omitted. The active connection between the securing cage 210 and the collar 101 with inner collar taper on the bottle neck 10 is permanent after the multi-part closure device has been pressed on in the direction of the longitudinal axis L.

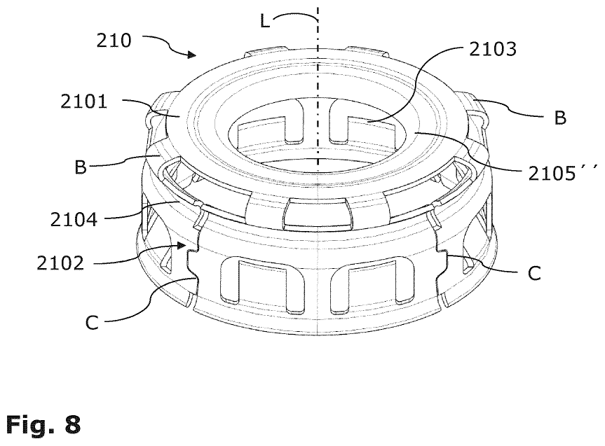

FIG. 8 shows an alternative securing cage 210 according to the invention in a simplified design. According to this embodiment of the securing cage 210, the centric ring 2101 holds several edge segments A together via several hinges B, just as in the other embodiments. Four edge segments A are selected here, each of which is non-detachably connected to one another via two hinges B, as a band between the centric ring 2101 and the edge segment A. Two undercut webs 2103 are formed or recessed in each of the edge segments A, which form parts of the side wall 2102. Facing the centric ring 2101, a part of the cage edge bead 2104 extends in each edge segment A. After the metal profile has been punched out, the remaining components must be cut and bent accordingly. As an option, the plug engagement edge 2105″, which runs centrally around the centric ring 2101 and faces the longitudinal axis L, is marked here. This optimizes the fastening between the securing cage 210 and the sealing plug 20.

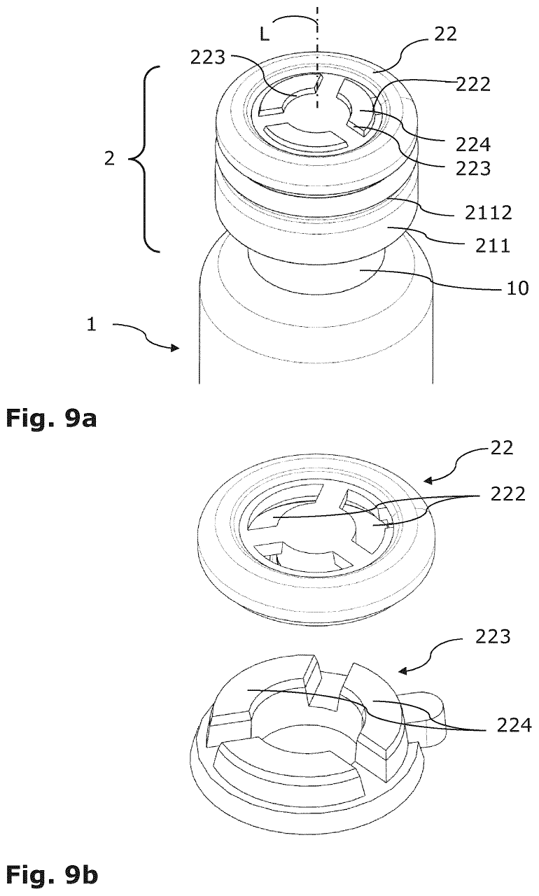

In addition, provisions in the protective cover 22 which allow the integrity of the multi-part closure device 2 to be checked can be advantageous. For this purpose, the protective cover 22 is preferably designed in several parts, more preferably in two parts, which is illustrated in FIGS. 9a and 9b. In addition to the layer of the protective cover 22, in which recesses 222 are provided, an additional transparent/translucent window layer 223 with at least one raised window 224 is provided. Here, a decision has been made in favor of three recesses 222 and a transparent/translucent window layer 223 with three window elevations 224. The window layer 223 should be transparent/translucent in such a way that the window elevations 224 provide a view as far as the sealing plug 20 or as far as the upper edge of the securing cage 210 and the outer cage shell 211. This makes it possible to assess whether the respective multi-part closure device 2 has already been opened once or whether one of the components has been destroyed or tampered with. Preferably, the protective cover 22 with protective cover layer and transparent/translucent window layer 223 is manufactured in an injection molding process. Transparent/translucent refers to a window layer 223 that allows at least 50% of the incident light to pass through so that conclusions can be drawn as to its intactness.

The advantage of all the multi-part closure devices 2 presented here is that several unsealed medical active substance containers 1 with matching multi-part closure devices 2 can be transported unfilled and unsealed to an active substance filling line, where they can be filled and also simply closed there. Without special tools at the filling location by the vaccine or active substance filler himself.

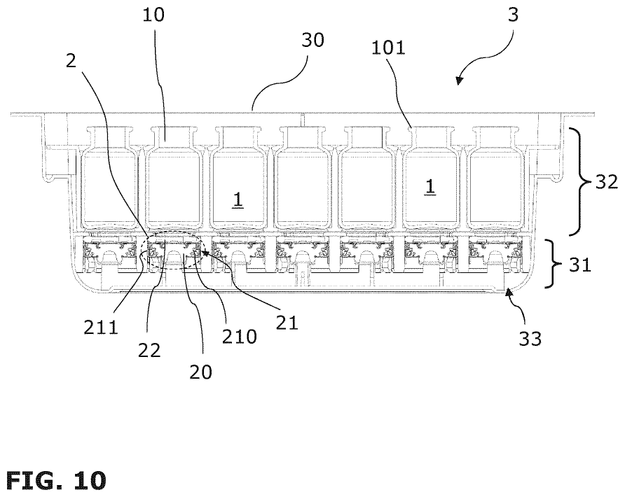

For this purpose, as shown in FIG. 10, a transport container 3, which can also be referred to as a delivery cassette 3, comprising a transport container tray 33, in which a first storage pallet 31 with multi-part closure devices 2 and a second storage pallet 32 with medical active substance containers 1, closed with a box lid 30 and/or a protective film 30, are delivered. The medical active substance containers 1 are unsealed, i.e. the openings of the medical active substance containers 1 at the bottle neck 10 are free.

The second storage pallet 32 with empty medical active substance containers 1 rests in the transport container tray on the first storage pallet with the multi-part closure devices 32.

A possible filling process for the medical active substance containers 1 is as follows. First, the transport container 3 or the transport container tray 33 is delivered to a filling system for medical active substances and made available to it. There, the box lid 30 and/or the protective film 30 is removed. The second storage pallet 32 with the medical active substance containers 1 is then removed from the transport container tray 33 and placed in the filling station, where the open medical active substance containers 1 arranged locally in the second storage pallet 32 are filled.

As soon as all the medical active substance containers 1 of the second storage pallet 32 have been filled, the complete first storage pallet 31, which is also removed from the transport container tray 33, is placed on the bottle necks of the filled medical active substance containers 1 and, by pressing the first storage pallet 31 towards the bottom of the transport container tray, each medical active substance container 1 is tightly closed with an associated closing device 31. When the first storage pallet 31 is pressed down towards the bottom of the transport container or towards the bottom of the medical active substance container 1, the multi-part closure devices 2 with their sealing plugs 20 and the plug securing device 21 are pressed onto the openings of the bottle necks 10. The undercut webs 2103 in the side wall 2102 of the securing cage 210 engage behind the collar end bead 102 and secure against unwanted opening of the medical active substance container 1. In order to ensure simple and fast closing, the arrangement of the closing devices 2 in the first storage pallet 31 is matched to the arrangement of the active substance containers in the second storage pallet 32, i.e. by placing and pressing the first storage pallet 31 onto the second storage pallet 32, the multi-part closing devices 2 engage with the bottle necks 10 of corresponding active substance medical containers 1 and close the respective active substance medical container 1. This enables simple and quick closing of the medical active substance containers 1.

After filling and closing the medical active substance containers 1, the second storage pallet 32 with the filled and closed medical active substance containers 1 can be repositioned in the transport container tray 33 and the transport container 3 can be closed with the box lid 30 and/or a protective film 30.

Known plastics, in particular thermoplastics, can be used as the material for the box lid 30, the storage pallets 31, 32 and the transport container tray 33. For example, a non-woven fabric made of high-density polyethylene has proven to be a suitable material for the protective film 30.

By delivering the transport container 3 with unsealed medical active substance containers 1, whereby the first storage pallet 31 and the second storage pallet 32 have coordinated positions of the sealing devices 2 and of the medical active substance containers, filling and sealing can be simplified and greatly accelerated. This filing and closing process does not have to be carried out by a specialized company. As several components are supplied in one package, in this case the transport container 3, for filling, a large amount of waste and a large transport volume can be avoided.

### List of reference signs

1 Medical active substance container/vial
10 bottle neck
101 Collar with inner collar taper
102 Collar end bead
103 Outer collar surface
104 Inner contact surface
2 Multi-part closure device
20 Sealing plugs (rubber, elastomer, TPE, self-closing)
201 Sealing lips
202 Edge
2021 Cage support surface
2022 Cage edge recess (concentric circumferential)
2022′ Cage edge recess (radially aligned to longitudinal axis L)
2023 Plug bead
203 Plug taper
21 plug securing device
210 securing cage
2101 centric ring (with centric opening) (one)
2101′ ring tab with plug engagement edge 2105′ (several)
2102 Side wall
2103 Undercut webs in side wall
2104 Cage edge bead
2105 Plug engagement edge (with several frame shapes arranged in the direction of rotation)
2105′ Plug engagement edge (end of the ring segment)
2105″ Plug engagement edge (end of the centric ring circumferential)
2106 Ring lugs
2107 Side edge reinforcement
2108 Ring reinforcement
2109 web reinforcement
A Edge segment
B Hinge
C Connection points
211 Outer cage shell (preferably metal, surrounding sheet metal)
2111 central opening
2112 Cage shell bead (circumferential engagement edge, analogous to 2104)
2113 Cover engagement (circumferential around 2111)
22 Protective cover (removable, plastic, profiled)
221 Engagement edge (protruding diagonally upwards, can be effectively connected with lid engagement)
222 centric taper/optional recesses
223 Transparent/translucent window layer
224 Window elevations in 223
3 Transport container/delivery cassette
30 Box lid/protective film
31 First storage pallet for locking devices (arranged with plural aligned)
32 Second storage pallet for medical active substance containers 1 (with a plurality of aligned, unsealed medical active substance containers 1)
33 Transport container tray

1. Multi-part closure device (2) for coupling to a medical active substance container (1) with a suitable collar (101) connected to a bottle neck (10) of the active substance container (1) ;
wherein the multi-part closure device (2) comprises a sealing plug (20), a plug securing device (21) and preferably a protective cover (22),
wherein the sealing plug (20) is adapted be secured to the active substance container (1) by means of the plug securing device (21), thereby sealing an opening in the bottle neck (10) of the active substance container (1) and permitting airtight removal of liquid active substance,
characterized in that
the plug securing device (21) comprises a securing cage (210) with a centric ring (2101), a central opening and a side wall (2102),
wherein the securing cage (210) has a plurality of undercut webs (2103) formed along the side wall (2102) and adapted to engage the collar (101) of the bottle neck (10), the undercut webs (2103) being bent in a tilted manner in the direction of a longitudinal axis (L) of the plug securing device (21); and the plug securing device (21) has an outer cage shell (211) which surrounds the securing cage (210) in a radially outwardly offset manner and has a central opening (2111);
wherein the cage shell (211) is made of metal or of plastic and/or wherein the cage shell (211) is connected to the securing cage (210) by material closure, in particular by gluing or welding, by form closure or by force closure.

2. Multi-part closure device (2) according to claim 1, wherein plug engagement edges (2105) are formed on the centric ring (2101) or on a plurality of ring tabs (2101′) arranged on the centric ring (2101), on the side of the centric ring (2101) facing the longitudinal axis (L) towards the centric opening, which can be operatively connected to a circumferential cage edge recess (2022, 2022′) on the sealing plug (20), so that the securing cage (210) is additionally secured against radial movements.

3. The multi-part closure device (2) according to claim 1, wherein a cage edge bead (2104) is provided circumferentially in the side wall (2102) of the securing cage (210).

4. Multi-part closure device (2) according to claim 1, wherein the undercut webs (2103) in the side wall (2102) are provided with web reinforcements (2109).

5. Multi-part closure device (2) according to claim 1, wherein a plurality of side edge reinforcements (2107) in the form of beads or embossments are arranged in the side wall (2102) so as to extend parallel to the longitudinal axis (L).

6. Multi-part closure device (2) according to claim 1, wherein the securing cage (211) is made in one piece and/or of metal, in particular of a stamped metal profile, or of plastic.

7. Multi-part closure device (2) according to claim 1, wherein the securing cage (210) comprises a plurality of edge segments (A) attached to the centric ring (2101) via hinges (B), wherein the edge segments (A) form the side wall (2102) of the securing cage (210), to which the plurality of undercut webs (2103) is molded, wherein the securing cage (210) is preferably made in one piece and preferably from a stamped metal profile.

8. Multi-part closure device (2) according to claim 7, wherein the edge segments (A) have connection points (C) at their ends in the direction of rotation, which are designed to engage with one another in the connection points (C) of the respective adjacent edge segments (A) ; or whereby adjacent edge segments (A) are welded together at their connection points (C).

9. Multi-part closure device (2) according to claim 1, wherein the sealing plug (20) is attached to the closure device (2), preferably to the securing cage (210), by material closure, in particular by bonding or welding, by form closure or by force closure; and/or
wherein the sealing plug (20) is detachably attached to the closure device (2).

10. Multi-part closure device (2) according to claim 1, wherein the outer cage shell (211) has a circumferentially molded-in cage shell bead (2112) which, in the assembled state, runs offset perpendicular to the longitudinal axis (L) at least approximately parallel to the cage edge bead (2104).

11. Multi-part closure device (2) according to claim 1, wherein a circumferential cover engagement (2113) is formed along the central opening (2111) of the outer cage shell (211), to which cover engagement an engagement edge (221) arranged on the protective cover (22) can be fastened.

12. Multi-part closure device (2) according to claim 1, wherein a plurality of side edge reinforcements (2107) in the form of beads or embossments are arranged in the side wall (2102) so as to extend parallel to the longitudinal axis (L), wherein the side edge reinforcements are designed in such a way that the securing cage (210) and the outer cage shell (211) are kept at a distance from each other, at least in certain regions.

13. Multi-part closure device (2) according to claim 1, wherein a plurality of radially outwardly pointing sealing lips (201) is arranged along the outer surface of the sealing plug (20) (20), the sealing lips (201) being made of an elastomer, in particular of rubber, TPE (thermoplastic elastomer) or TPU (thermoplastic polyurethane), in particular three sealing lips (201) are arranged as material projecting away in the direction of an inner contact surface (104) of the collar (101);
preferably whereby a central plug taper (203) is recessed in the center of the sealing plug (20).

14. The multi-part closure device (2) according to claim 13, wherein a plurality of plug beads (2023) is formed along a cage support surface (2021) on the edge (202) of the sealing plug (20) and/or along the outer surface of the edge (202) in the center of the sealing plug (20).

15. Multi-part closure device (2) according to claim 1, wherein the multi-part closure device (2) has a protective cover (22) which is produced in two parts and has recesses (222) into which window elevations (224) of a transparent/translucent window layer (223) project at least partially.

16. Medical active substance container (1) with a multi-part closure device (2) according to claim 1, characterized in that the medical active substance container (1) has a bottle neck (10), with an inner contact surface (104) matched to the sealing plug (20) with at least one sealing lip (201) of the sealing plug (20), with a collar (101) and a collar end bead (102) for non-detachably fastening the multi-part closure device (2) to the collar (101) ; preferably whereby
the collar (101) has an outer collar surface (103) with a circumferential bead which is suitable for engaging with the undercut webs (2103).

17. Use of a multi-part closure device (2) according to claim 1 as a closure of a medical active substance container (1) for preventing contamination of the interior of the medical active substance container (1), the container (1) allowing the removal of active substance or vaccine from the interior by means of draw-up or inoculation syringes, transfer devices such as transfer cannulas, or syringe adapters, wherein the multi-part closure device (2) can be pressed onto a collar (101) with a collar end bead (102), which collar is connected to a bottle neck (10) of the active substance container (1), by pressing it in the direction of the longitudinal axis (L) of the active substance container (1) and is then held in non-detachable contact with the sealing plug (20) against the inner contact surface (104), wherein the plurality of undercut webs (2103) formed along the side wall (2102) of the securing cage (210) engage on the collar (101) of the bottle neck (10).
